(19) United States
(12) Patent Application Publication
(10) Pub. No.: US 2026/0038750 A1
(43) Pub. Date: Feb. 5, 2026

(54) SWITCH DEVICE

(71) Applicant: Alps Alpine Co., Ltd., Tokyo (JP)

(72) Inventor: Hiroshi OHARA, Miyagi-ken (JP)

(21) Appl. No.: 19/279,211

(22) Filed: Jul. 24, 2025

(30) Foreign Application Priority Data
Jul. 30, 2024 (JP) 2024-123635

(51) Int. Cl. H01H 13/14; H01H 13/20

(52) U.S. Cl. CPC H01H 13/14; H01H 13/20

(57) ABSTRACT

A switch device includes a housing having an accommodation portion, a peripheral fixed contact and a central fixed contact provided at a bottom of the accommodation portion, a movable contact member including a base portion on the bottom of the accommodation portion and in contact with the peripheral fixed contact, an elastic arm extending from a central portion of the base portion and capable of releasably connecting the central fixed contact, and a pair of support legs extending from both ends of the base portion, an operation member on which an operator performs a push-down operation, a plate spring provided below the operation member in the accommodation portion and pressed by the operation member, and a drive body provided above the elastic arm and below the plate spring, causing the elastic arm to contact the central fixed contact by pressed by the plate spring and pushing down the elastic arm.

### CLAIM OF PRIORITY

This application claims benefit of Japanese Patent Application No. 2024-123635 filed on Jul. 30, 2024, which is hereby incorporated by reference.

### BACKGROUND OF THE INVENTION

### 1. Field of the Invention

The present invention relates to a switch device.

### 2. Description of the Related Art

U.S. Pat. No. 4,931,605 discloses a technology for simultaneously switching two systems in a switch circuit by pressing a pair of contact members simultaneously with a plunger when a push operation is performed on a button in a push button switch.

However, according to the technology of U.S. Pat. No. 4,931,605, a plunger is required to press two contacts per contact member, meaning that the plunger is required to press a total of four contacts for a pair of contact members, so that the switch has a complex structure and poor contact pressing may occur.

### SUMMARY OF THE INVENTION

A switch device according to an embodiment includes a housing having an accommodation portion, a peripheral fixed contact and a central fixed contact provided at a bottom of the accommodation portion, a movable contact member including a base portion placed on the bottom of the accommodation portion and in contact with the peripheral fixed contact, an elastic arm portion extending from a central portion of the base portion and capable of releasably connecting the central fixed contact, and a pair of support legs extending from both ends of the base portion, an operation member on which an operator performs a push-down operation, a plate spring provided below the operation member in the accommodation portion and pressed by the operation member, and a drive body provided above the elastic arm and below the plate spring in the accommodation portion, the drive body causing the elastic arm to contact the central fixed contact by pressed by the plate spring and pushing down the elastic arm.

According to the switch device of an embodiment, it is possible to turn on the switch in the switch circuit more reliably by a relatively simple configuration.

### BRIEF DESCRIPTION OF THE DRAWINGS

FIG. 1 is an external perspective view of a switch device according to an embodiment;

FIG. 2 is a plan view of the switch device according to an embodiment;

FIG. 3 is a circuit diagram of a switch circuit included in the switch device according to an embodiment;

FIG. 4 is an exploded perspective view of the switch device according to an embodiment;

FIG. 5 is a perspective sectional view of the switch device according to an embodiment;

FIG. 6 is a plan view of the housing included in the switch device according to an embodiment;

FIG. 7 is a plan view of the housing (with a pair of movable contact members being disposed) included in the switch device according to an embodiment;

FIG. 8 is a plan view of the housing (with a drive body being disposed) included in the switch device according to an embodiment;

FIG. 9 is a plan view of the housing (with an inversion dome member being disposed) included in the switch device according to an embodiment;

FIG. 10 is a cross-sectional view of the switch device according to an embodiment in the state at the normal time;

FIG. 11 is a cross-sectional view of the switch device in an embodiment in the state of the time of the push-down operation;

FIG. 12 is a cross-sectional view of a switch device according to the first modification of an embodiment;

FIG. 13 is an exploded perspective view of the switch device according to the first modification of an embodiment;

FIG. 14 is a cross-sectional view of a switch device according to the second modification of an embodiment; and

FIG. 15 is an exploded perspective view of the switch device according to the second modification of an embodiment.

### DESCRIPTION OF THE PREFERRED EMBODIMENTS

Hereinafter, an embodiment will be described with reference to the drawings. In the following description, for convenience, the Z axis direction in the figure is the vertical direction, the Y axis direction in the figure is the front-back direction, and the X axis direction in the figure is the left-right direction. The Z axis positive direction is the upward direction, the Y axis positive direction is the right direction, and the X axis positive direction is the forward direction.

### <Overview Of Switch Device 100>

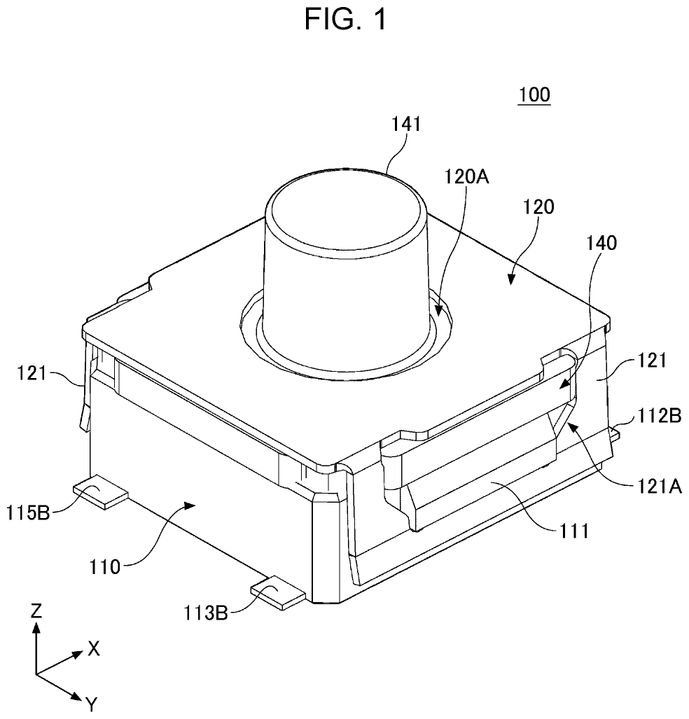

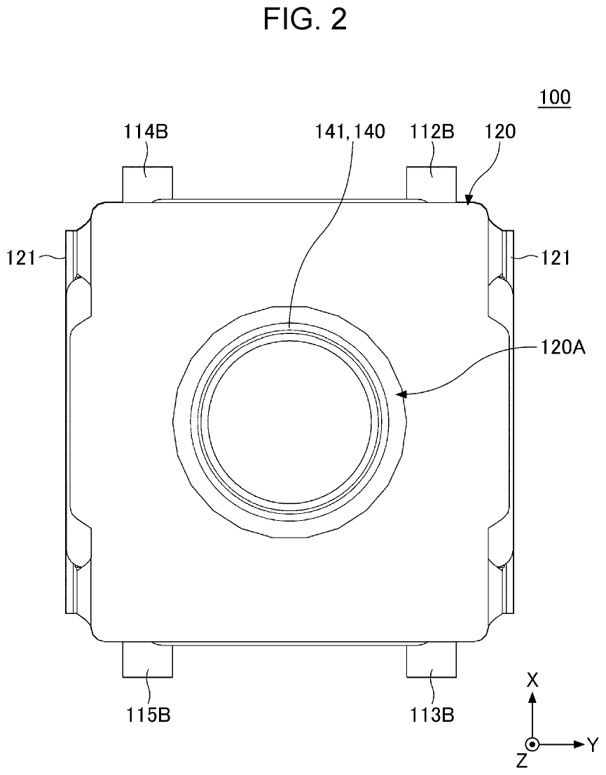

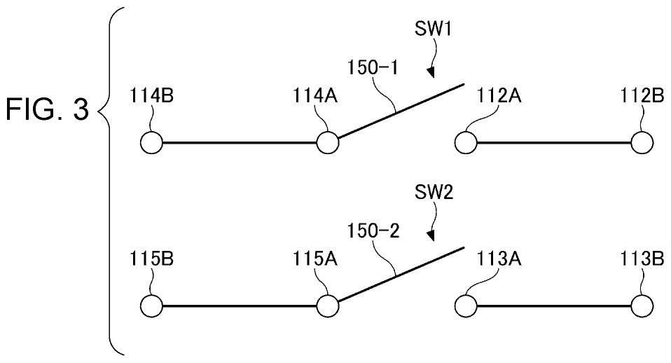

FIG. 1 is an external perspective view of a switch device 100 according to an embodiment. FIG. 2 is a plan view of the switch device 100 according to an embodiment. FIG. 3 is a circuit diagram of a switch circuit included in the switch device 100 according to an embodiment.

As shown in FIG. 1, the switch device 100 according to an embodiment has a configuration in which a stem 140 and a frame 120 are attached at the upper portion of a housing 110 having a rectangular parallelepiped shape. A circular opening 120A is formed in the central portion of the frame 120. From the opening 120A, a cylindrical operation unit 141 of the stem 140 protrudes upward. The switch device 100 allows the operator to perform the push-down operation on the operation unit 141 of the stem 140.

As shown in FIGS. 1 and 2, the switch device 100 includes a pair of left and right external connection terminals 114B and 112B protruding forward (X axis positive direction) from the lower end of the front side (X axis positive side) wall of the housing 110. In addition, the switch device 100 includes a pair of left and right external connection terminals 115B and 113B protruding rearward (X axis negative direction) from the lower end of the rear side (X axis negative side) wall of the housing 110.

As shown in FIG. 3, the circuit configuration of the switch circuit included in the switch device 100 has a first system and a second system. The first system includes external connection terminals 114B and 112B and a switch SW1. The switch SW1 is provided between the external connection terminal 114B and the external connection terminal 112B. The switch SW1 includes a peripheral fixed contact 114A, a central fixed contact 112A, and a movable contact member 150-1. The second system includes external connection terminals 115B and 113B and a switch SW2. The switch SW2 is provided between the external connection terminal 115B and the external connection terminal 113B. The switch SW2 includes a peripheral fixed contact 115A, a central fixed contact 113A, and a movable contact member 150-2.

The switch device 100 can turn on a first system switch SW1 and a second system switch SW2 simultaneously when the operator performs the push-down operation on the operation unit 141 of the stem 140. In the first system, when the switch SW1 is turned on, the external connection terminal 114B and the external connection terminal 112B are electrically connected to each other. In the second system, when the switch SW2 is turned on, the external connection terminal 115B and the external connection terminal 113B are electrically connected to each other.

### <Configuration Of Switch Device 100>

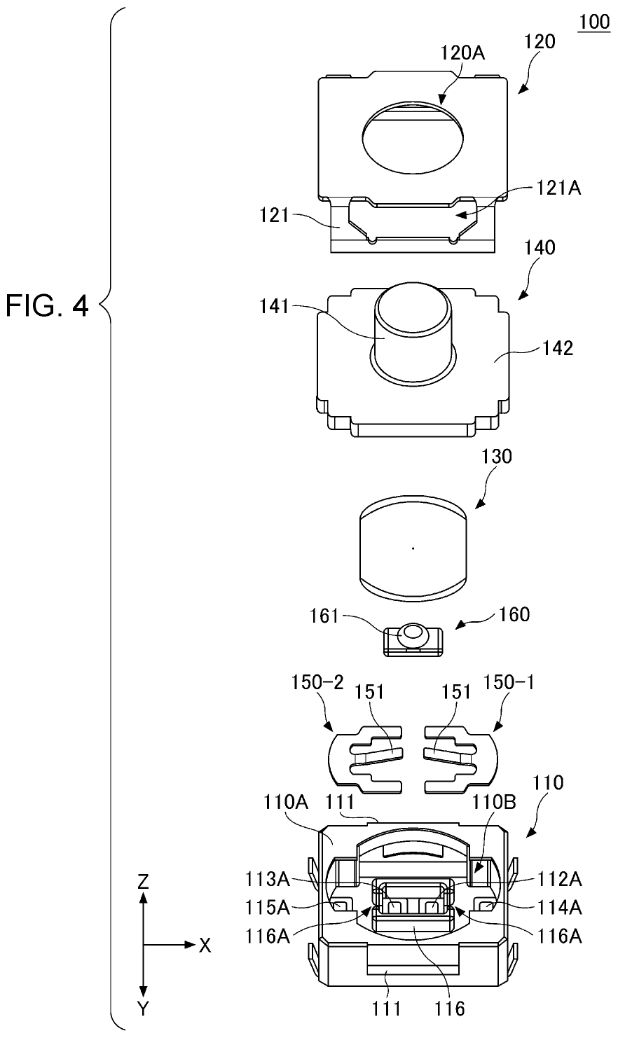

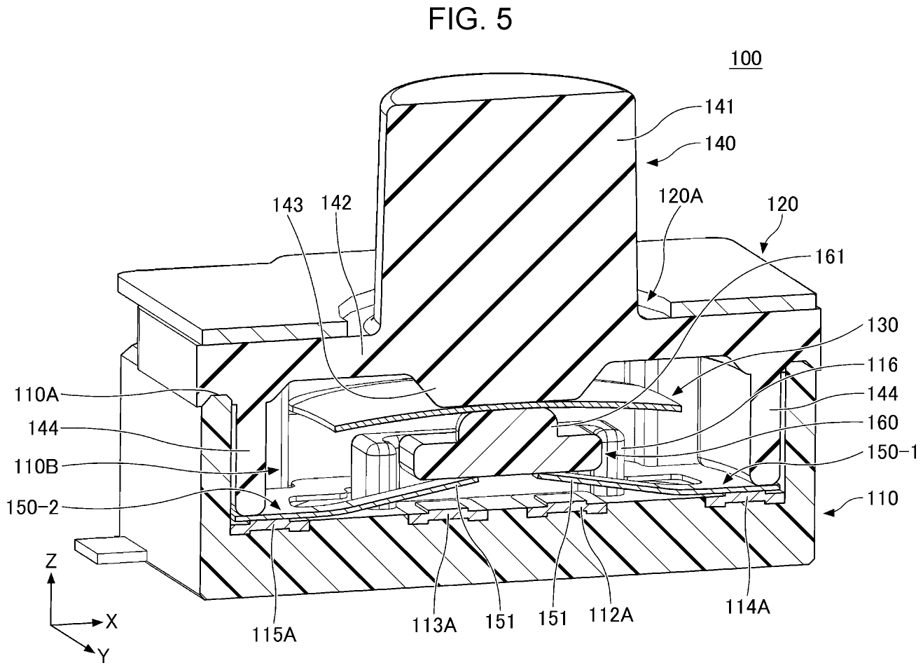

FIG. 4 is an exploded perspective view of the switch device 100 according to an embodiment. FIG. 5 is a perspective cross-sectional view of the switch device 100 according to an embodiment. As shown in FIGS. 4 and 5, the switch device 100 includes the housing 110, the pair of movable contact members 150-1 and 150-2, the stem 140, an inversion dome member 130, a drive body 160, and the frame 120.

The housing 110 is a container-like member having a thin rectangular parallelepiped shape in the vertical direction (Z axis direction). The housing 110 has a substantially square shape when viewed from above. The housing 110 includes an accommodation portion 110B that is a space with a recessed shape extending downward from an upper face 110A. The accommodation portion 110B accommodates the pair of movable contact members 150-1 and 150-2, the inversion dome member 130, and the drive body 160. For example, the housing 110 is formed by insert molding using a relatively hard insulating material (for example, hard resin).

The housing 110 has a claw 111 protruding outward on each of a pair of left and right side faces. The claw 111 allows the frame 120 and the stem 140 to be fixed to the housing 110 by hooking a hook 121 by being fitted into an opening 121A of the hook 121 of the frame 120 when the frame 120 is attached to the upper face 110A of the housing 110.

Two central fixed contacts 112A and 113A and a substantially rectangular tubular support wall 116 surrounding the two central fixed contacts 112A and 113A at the central portion of the bottom of the accommodation portion 110B of the housing 110. Inside the support wall 116, the drive body 160 is disposed so as to be movable in the vertical direction (Z axis direction). Furthermore, the drive body 160 is disposed inside the substantially rectangular tubular support wall 116 provided at the central portion of the bottom of the accommodation portion 110B of the housing 110, thereby being movably supported by the support wall 116 in the vertical direction (Z axis direction). Each of the front side (X axis positive side) wall and the rear side (X axis negative side) wall of the support wall 116 has a slit 116A through which an elastic arm 151 of each of the movable contact members 150-1 and 150-2 passes.

The pair of movable contact members 150-1 and 150-2 is members made of horizontal metal plates and are placed on the bottom of the accommodation portion 110B of the housing 110.

Specifically, the movable contact member 150-1 is placed in the front (X axis positive side) region of the bottom of the accommodation portion 110B of the housing 110. The movable contact member 150-1 is constantly in contact with the peripheral fixed contact 114A provided at the bottom of the accommodation portion 110B of the housing 110.

In addition, the movable contact member 150-2 is placed in the rear side (X axis negative side) region of the bottom of the accommodation portion 110B of the housing 110. The movable contact member 150-1 is constantly in contact with the peripheral fixed contact 115A provided at the bottom of the accommodation portion 110B of the housing 110.

Each of the pair of movable contact members 150-1 and 150-2 has the elastic arm 151 extending in a straight line in the front-rear direction (X axis direction) and obliquely upward toward the central portion of the accommodation portion 110B at the central portion in the left-right direction (Y axis direction). The elastic arm 151 extends, through the slit 116A formed in the support wall 116, into the interior of the support wall 116, and up to above each of the central fixed contacts 112A and 113A. When the operator performs the push-down operation on the operation unit 141 of the stem 140, the elastic arm 151 is pushed down by the drive body 160 and elastically deforms downward (Z axis negative direction), thereby coming into contact with each of the central fixed contacts 112A and 113A.

The stem 140 is an example of an “operation member” on which the operator performs the push-down operation downward. The stem 140 is installed on the upper face 110A of the housing 110 so as to close the upper opening of accommodation portion 110B of the housing 110. The stem 140 is formed of an elastic material (for example, rubber, silicone, etc.). The stem 140 includes the operation unit 141, a base portion 142, and a central protrusion 143.

The base portion 142 is a horizontal flat plate portion. When viewed from above, the outer shape of the base portion 142 is substantially the same (i.e., substantially square) as the upper face 110A of the housing 110. The stem 140 is fixed to the upper face 110A of the housing 110 by the base portion 142 being pressed from above by the frame 120.

The operation unit 141 is provided protruding upward from the central portion of the upper face of the base portion 142 and has a cylindrical shape. The operation unit 141 passes through the opening 120A of the frame 120 and is pushed down by the operator.

The central protrusion 143 is provided protruding downward from the central portion of the lower face of the operation unit 141 and has a columnar shape.

With the stem 140, when the operator performs the push-down operation on the operation unit 141, the base portion 142 elastically deforms, causing the operation unit 141 and the central protrusion 143 to move downward (Z axis negative direction), thereby enabling the bottom face of the central protrusion 143 to press against the top of the inversion dome member 130.

As shown in FIG. 5, the stem 140 includes the pair of wall-like front-rear pressing legs 144 extending downward from the lower face of the base portion 142. Since the stem 140 is integrally formed using an elastic material, the pressing legs 144 also have elasticity. The front side (X axis positive side) pressing leg 144 presses a base portion 152 of the movable contact member 150-1 from above within the accommodation portion 110B, thereby pressing the base portion 152 of the movable contact member 150-1 against the peripheral fixed contact 114A. The rear side (X axis negative side) pressing leg 144 presses the base portion 152 of the movable contact member 150-2 from above within the accommodation portion 110B, thereby pressing the base portion 152 of the movable contact member 150-2 against the peripheral fixed contact 115A. As a result, the switch device 100 according to an embodiment can stably maintain a state in which the base portion 152 of the movable contact member 150-1 is in contact with the peripheral fixed contact 114A, and a state in which the base portion 152 of the movable contact member 150-2 is in contact with the peripheral fixed contact 115A.

The inversion dome member 130 is an example of a “plate spring”. The inversion dome member 130 is a member made of a thin metal plate and having a dome shape that is convex toward the upper side (Z axis positive direction). The inversion dome member 130 is disposed on the underside of the central protrusion 143 of the stem 140 in the accommodation portion 110B of the housing 110. When the operator performs the push-down operation on the operation unit 141 of the stem 140, the top (center portion) of the inversion dome member 130 is pushed downward by the central protrusion 143 of the stem 140, and when the operating load exceeds a predetermined value, the top rapidly deforms elastically into a recessed shape (inversion motion). This allows the inversion dome member 130 to press down the drive body 160 at the underside of its top.

In the present embodiment, the inversion dome member 130 has a side-cut shape (i.e., a substantially elongated circular shape with the front-rear direction (X axis direction) as the longitudinal direction) in which the left and right sides are cut by a pair of parallel straight portions 131 with respect to a dome-shaped material having a circular shape in plan view. This enables the size of the inversion dome member 130 to be reduced in the left-right direction (Y axis direction).

The drive body 160 is a resin-made, flat plate member provided on the upperside of the pair of elastic arms 151 (i.e., the elastic arm 151 of each of the pair of movable contact members 150-1 and 150-2) and on the underside of the inversion dome member 130 in the accommodation portion 110B of the housing 110. The drive body 160 has a rectangular shape with the front-rear direction as the longitudinal direction in plan view from above. In addition, the drive body 160 has a cylindrical protrusion 161 extending upward from the central portion of the upper face.

When the operator performs the push-down operation on the operation unit 141 of the stem 140, the drive body 160 moves downward as a whole due to the protrusion 161 being pushed down by the inversion dome member 130, and pushes down each of the pair of elastic arms 151 with the bottom face, thereby causing the pair of elastic arms 151 to contact the central fixed contacts 112A and 113A provided at the central portion of the bottom of the accommodation portion 110B of the housing 110. This allows the drive body 160 to turn on the switch SW1 of the first system and to turn on the switch SW2 of the second system with respect to the switch circuit included in the switch device 100 (see FIG. 3). Furthermore, the drive body 160 is disposed inside the substantially rectangular tubular support wall 116 provided at the central portion of the bottom of the accommodation portion 110B of the housing 110. As a result, the drive body 160 is positioned at the central portion of the accommodation portion 110B of the housing 110 by the support wall 116, and is movably supported in the vertical direction (Z axis direction) and the rotation is suppressed.

The frame 120 is a flat plate metal member. The frame 120 is fixedly mounted on the upper face 110A of the housing 110 with the stem 140 positioned on the upper face 110A of the housing 110, thereby pressing down the base portion 142 of the stem 140 from above.

For example, the frame 120 is formed by processing a metal plate using a processing method such as press working. When viewed from above, the circular opening 120A is formed in the central portion of the frame 120 for the operation unit 141 of the stem 140 protruding upward.

In addition, the hook 121 extending downward is provided on each of a pair of left and right sides of the outer peripheral edge of the frame 120. The hook 121 has the rectangular opening 121A, and the claw 111 provided on the side face of the housing 110 is fitted into the opening 121A. This allows the hook 121 to be hooked onto the claw 111, thereby fixing the frame 120 to the housing 110.

### <Configuration Of Housing 110>

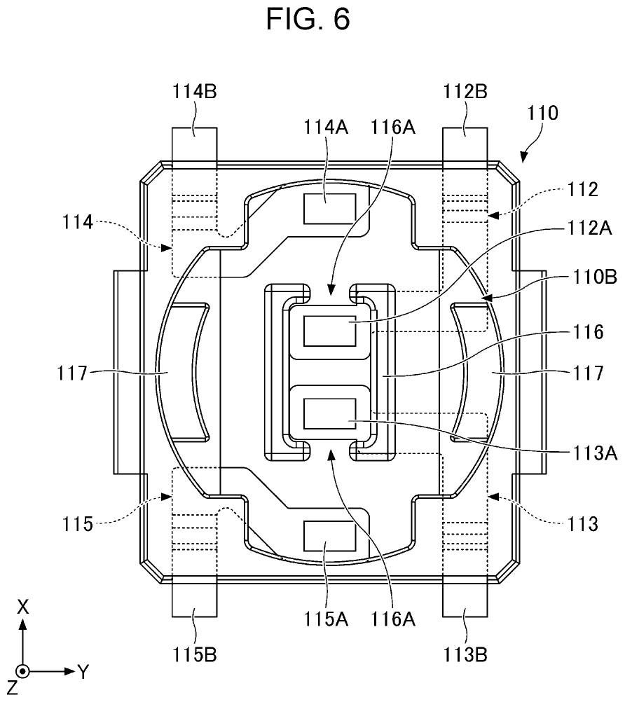

FIG. 6 is a plan view of the housing 110 included in the switch device 100 according to an embodiment. As shown in FIG. 6, the housing 110 includes the accommodation portion 110B which, when viewed from above, has a shape formed by the intersection of a substantially elongated circular shape extending in the front-rear direction (X axis direction) and a substantially elongated circular shape extending in the left-right direction (Y axis direction) (i.e., a substantially cross-shaped shape).

Furthermore, as shown in FIG. 6, four fixed contact members 112, 113, 114, and 115, each made of a conductive plate material (for example, a metal plate), are embedded by insert molding into the bottom of the housing 110.

The fixed contact members 112 and 114 are embedded into the front side (X axis positive side) portion of the bottom of the housing 110 and constitute the first system (see FIG. 3) in the circuit configuration of the switch device 100.

The fixed contact member 112 has the rectangular central fixed contact 112A at one end and the external connection terminal 112B at the other end. As shown in FIG. 6, the central fixed contact 112A is provided at the central portion (inside the support wall 116) of the bottom of the accommodation portion 110B of the housing 110 with exposed on the front side (X axis positive side), and faces the central fixed contact 113A.

The fixed contact member 114 has the rectangular peripheral fixed contact 114A at one end and the external connection terminal 114B at the other end. As shown in FIG. 6, the peripheral fixed contact 114A is provided at the front end (the X axis positive side end) of the bottom of the accommodation portion 110B of the housing 110 in an exposed manner.

The fixed contact members 113 and 115 are embedded into the rear side (X axis negative side) portion of the bottom of the housing 110 and constitute the second system (see FIG. 3) in the circuit configuration of the switch device 100.

The fixed contact member 113 has the rectangular central fixed contact 113A at one end and the external connection terminal 113B at the other end. As shown in FIG. 6, the central fixed contact 113A is provided at the central portion (inside the support wall 116) of the bottom of the accommodation portion 110B of the housing 110 with exposed on the rear side (X axis negative side), and faces the central fixed contact 112A.

The fixed contact member 115 has the rectangular peripheral fixed contact 115A at one end and the external connection terminal 115B at the other end. As shown in FIG. 6, the peripheral fixed contact 115A is provided at the rear end (the X axis negative side end) of the bottom of the accommodation portion 110B of the housing 110 in an exposed manner.

<Housing 110 with a Pair of Movable Contact Members 150-1 and 150-2 being Disposed>

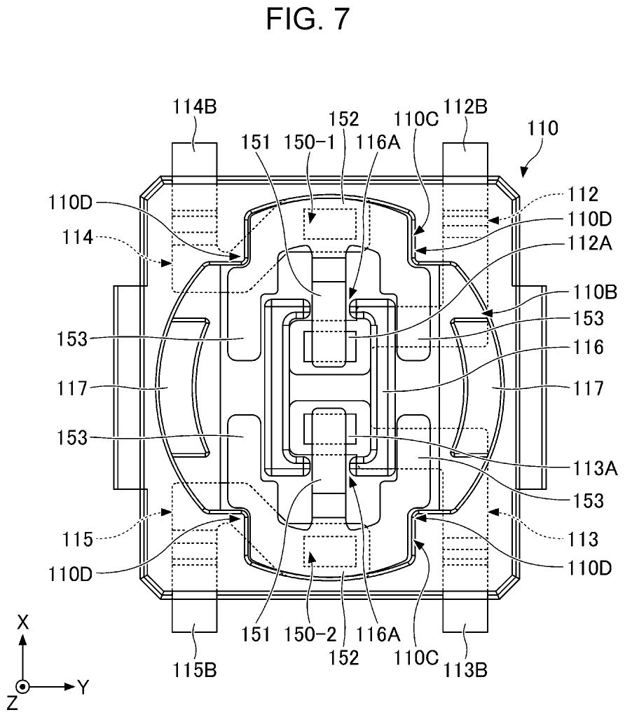

FIG. 7 is a plan view of the housing 110 (with a pair of movable contact members 150-1 and 150-2 being disposed) included in the switch device 100 according to an embodiment. As shown in FIG. 7, the pair of front-rear movable contact members 150-1 and 150-2, which have symmetrical shapes, is placed at the bottom of the accommodation portion 110B of the housing 110.

Each of the movable contact members 150-1 and 150-2 includes the base portion 152 extending in a substantially straight line in the left-right direction (Y axis direction) at the outermost position in the front-rear direction (X axis direction). As shown in FIG. 7, the accommodation portion 110B of the housing 110 has a pair of front-rear convex spaces 110C that protrude forward (X axis positive direction) and rearward (X axis negative direction) in plan view from a space having a substantially rectangular shape extending in the left-right direction (Y axis direction). As shown in FIG. 7, the base portion 152 of each of the movable contact members 150-1 and 150-2 has a shape substantially identical to that of the convex space 110C and is fitted into the inner side of the convex space 110C.

The peripheral fixed contact 114A is provided on the bottom face of the front side (X axis positive side) convex space 110C in an exposed manner. For this reason, the movable contact member 150-1 is in contact with the peripheral fixed contact 114A at the base portion 152. Furthermore, as described above, the base portion 152 of the movable contact member 150-1 is pushed from above by the pressing leg 144 of the stem 140, thereby stably maintaining the contact state with the peripheral fixed contact 114A.

The peripheral fixed contact 115A is provided on the bottom face of the rear side (X axis negative side) convex space 110C in an exposed manner. For this reason, the movable contact member 150-2 is in contact with the peripheral fixed contact 115A at the base portion 152. Furthermore, as described above, the base portion 152 of the movable contact member 150-2 is pushed from above by the pressing legs 144 of the stem 140, thereby stably maintaining the contact state with the peripheral fixed contact 115A.

In addition, each of the movable contact members 150-1 and 150-2 has the elastic arm 151 extending in a straight line from the base portion 152 toward the central portion of the accommodation portion 110B at the central portion in the left-right direction (Y axis direction).

The elastic arm 151 of the movable contact member 150-1 extends, through the front side (X axis positive side) slit 116A of the support wall 116, into the interior of the support wall 116, and up to above the central fixed contact 112A. That is, the distal end of the elastic arm 151 of the movable contact member 150-1 is away from the central fixed contact 112A and positioned above the central fixed contact 112A.

The elastic arm 151 of the movable contact member 150-2 extends, through the rear side (X axis negative side) slit 116A of the support wall 116, into the interior of the support wall 116, and up to above the central fixed contact 113A. That is, the distal end of the elastic arm 151 of the movable contact member 150-2 is away from the central fixed contact 113A and positioned above the central fixed contact 113A.

Furthermore, each of the movable contact members 150-1 and 150-2 has a pair of mutually parallel left and right support legs 153 that extend in a straight line in the X axis direction toward the central portion of the accommodation portion 110B from the base portion 152 at both ends in the left-right direction (Y axis direction). As a result, the switch device 100 according to an embodiment is configured so that the left and right both ends (i.e., the pair of left and right support legs 153) of each of the movable contact members 150-1 and 150-2 are stably supported by the bottom of the accommodation portion 110B.

Here, as shown in FIG. 7, each of the pair of left and right support legs 153 has a bent shape (crank shape) along the inner wall of the accommodation portion 110B. Specifically, each of the pair of left and right support legs 153 has an outer edge that is bent at a right angle along a right-angled corner 110D of the inner wall of the accommodation portion 110B. Furthermore, each of the pair of left and right support legs 153 has an inner edge that is bent at a right angle along the corner of the support wall 116. As a result, the switch device 100 according to an embodiment allows each of the movable contact members 150-1 and 150-2 to be easily positioned within the accommodation portion 110B from above (Z axis positive direction) of the accommodation portion 110B. Furthermore, the inner wall (right-angled corner 110D) of the accommodation portion 110B and the corners of the support wall 116 guide the movable contact members 150-1 and 150-2 to accurately their respective correct positions based on their respective correct orientations.

### <Housing 110 With Drive Body 160 Being Disposed>

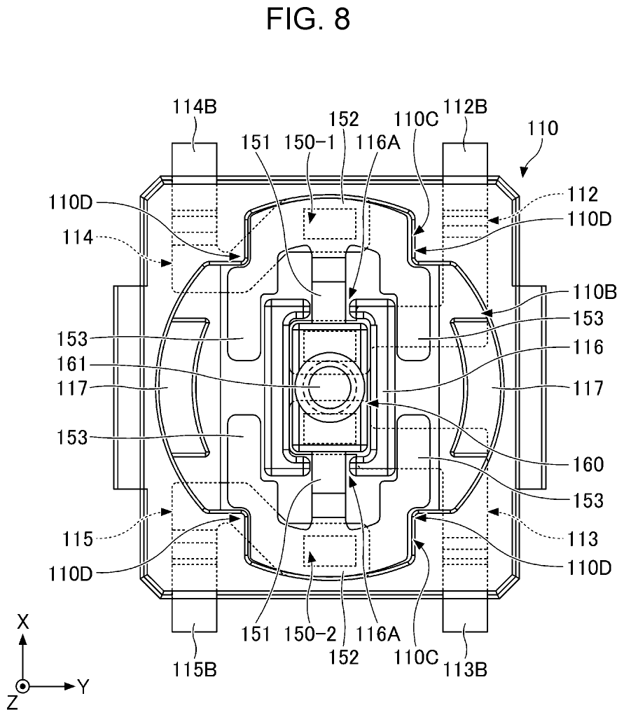

FIG. 8 is a plan view of the housing 110 (with the drive body 160 being disposed) included in the switch device 100 according to an embodiment. As shown in FIG. 8, the drive body 160 has a substantially elongated circular shape with the front-rear direction (X axis direction) as the longitudinal direction when viewed from above. As shown in FIG. 8, the drive body 160 is disposed in the inner space of the support wall 116 having a shape substantially identical to that of the drive body 160 so that the drive body 160 overlaps the upperside of the distal end of each of the pair of front-rear elastic arms 151, and has. This allows the drive body 160 to be held movably in the vertical direction (Z axis direction) by the support wall 116. Furthermore, the drive body 160 can push down the distal end of each of the pair of front-rear elastic arms 151 by moving downward (Z axis negative direction) as the protrusion 161 is pressed by the inversion dome member 130.

### <Housing 110 With Inversion Dome Member 130 Disposed Therein>

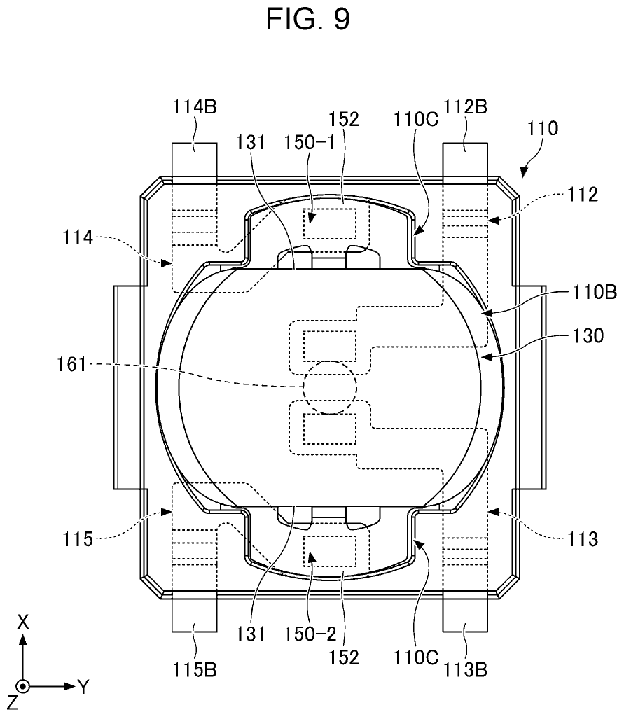

FIG. 9 is a plan view of the housing 110 (with the inversion dome member 130 being disposed) included in the switch device 100 according to an embodiment. As shown in FIG. 9, the inversion dome member 130 has a substantially elongated circular shape with the left-right direction (Y axis direction) as the longitudinal direction when viewed from above. As shown in FIG. 9, the inversion dome member 130 is disposed in a space (a space other than the convex space 110C) of a portion of the accommodation portion 110B of the housing 110, which has a shape substantially identical to that of the inversion dome member 130, so that the central portion of the inversion dome member 130 overlaps the upperside of the protrusion 161 of the drive body 160.

As a result, the switch device 100 according to an embodiment allows the inversion dome member 130 to be easily positioned in a predetermined orientation at a predetermined location relative to the accommodation portion 110B of the housing 110, and the inner wall of the accommodation portion 110B to suppress rotation of the inversion dome member 130.

Here, as shown in FIG. 9, the inversion dome member 130 is disposed so that the direction (Y axis direction) in which the pair of straight portions 131 extends is perpendicular to the direction (X axis direction) in which the elastic arm 151 of each of the movable contact members 150-1 and 150-2 extends. As a result, in the switch device 100 according to an embodiment, when viewed from above with the housing 110 having the inversion dome member 130 disposed therein, the inversion dome member 130 can be disposed so as not to overlap with the base portion 152 of each of the movable contact members 150-1 and 150-2 disposed at the bottom of the convex space 110C, and therefore, the base portion 152 of each of the movable contact members 150-1 and 150-2 can be pushed from above by the pressing leg 144 of the stem 140 without interfering with the inversion dome member 130.

Additionally, the switch device 100 according to an embodiment includes a pair of pedestals 117 having a higher bottom face at the left and right both ends of the accommodation portion 110B of the housing 110 (see FIGS. 6 to 8). By placing the left and right both ends of the inversion dome member 130 on the pair of pedestals 117, the inversion dome member 130 is disposed at a predetermined height position above the drive body 160.

### <Operation Of Switch Device 10>

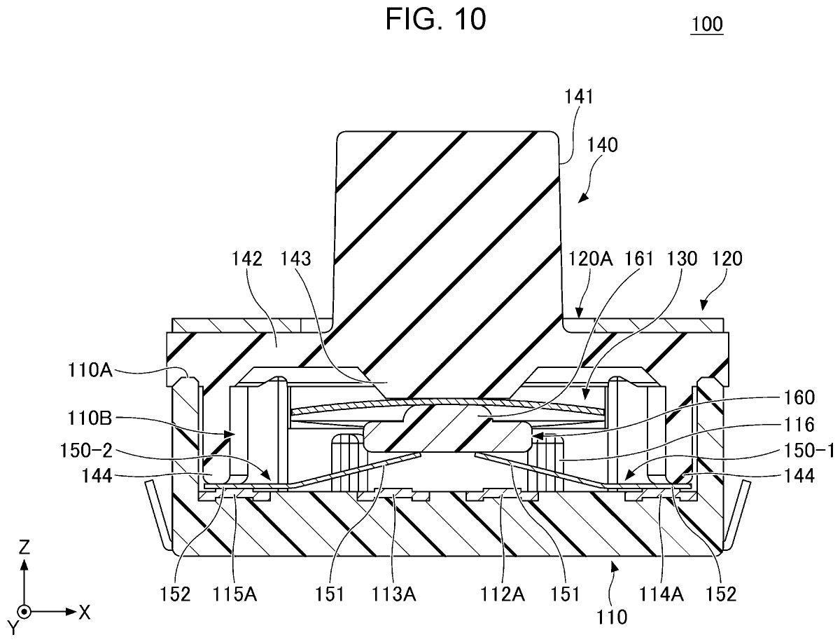

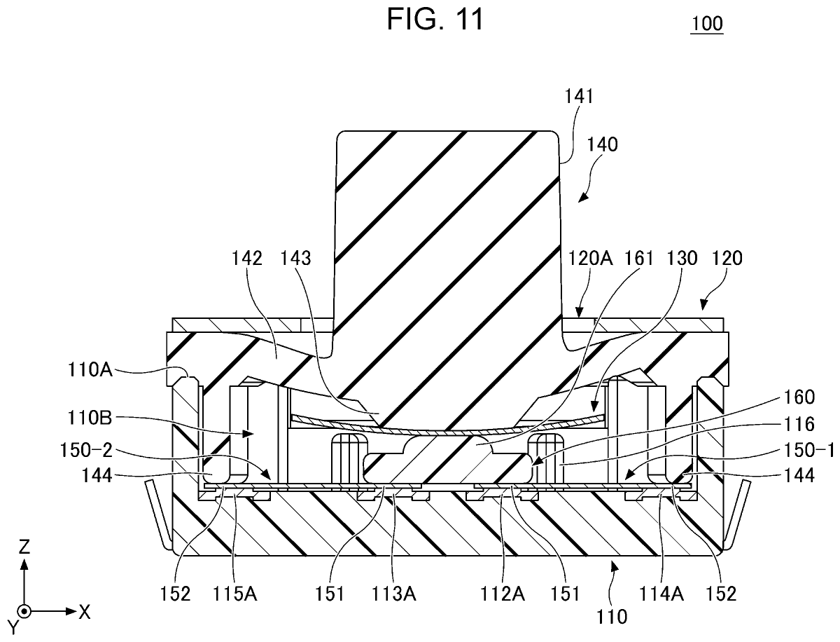

FIG. 10 is a cross-sectional view of the switch device 100 according to an embodiment in the state at the normal time. FIG. 11 is a cross-sectional view of the switch device 100 according to an embodiment in the state at the time of the push-down operation.

As shown in FIG. 10, when no push-down operation is performed by the operator on the operation unit 141 of the stem 140, the switch device 100 according to an embodiment is in an initial state in which the base portion 142 of the stem 140 is in a horizontal state, the operation unit 141 of the stem 140 is at the highest position, and the inversion dome member 130 is convex upward. In addition, the drive body 160 provided on the underside of the inversion dome member 130 is also in its initial state at the highest position.

At this time, the movable contact member 150-1 provided on the front side (X axis positive side) is in contact with the peripheral fixed contact 114A at the base portion 152, but the elastic arm 151 is not in contact with the central fixed contact 112A. Therefore, the first system switch SW1 that includes the movable contact member 150-1 is turned off.

Also, at this time, the movable contact member 150-2 provided on the rear side (X axis negative side) is in contact with the peripheral fixed contact 115A at the base portion 152, but the elastic arm 151 is not in contact with the central fixed contact 113A. Therefore, the second system switch SW2 that includes the movable contact member 150-2 is turned off.

As shown in FIG. 11, when the operator performs the push-down operation on the operation unit 141 of the stem 140, in the switch device 100 according to an embodiment, the base portion 142 of the stem 140 elastically deforms, and the operation unit 141 and the central protrusion 143 of the stem 140 move downward (Z axis negative direction).

This causes the central protrusion 143 of the stem 140 to push down the top of the inversion dome member 130. As a result, the inversion dome member 130 elastically deforms in a recessed shape (inversion motion), and the underside of the top of the inversion dome member 130 presses against the protrusion 161 of the drive body 160, thereby pushing down the drive body 160. The drive body 160 moves downward (Z axis negative direction) inside the support wall 116, thereby pushing down the distal end of the elastic arm 151 of each of the movable contact members 150-1 and 150-2.

As a result, when the elastic arm 151 comes into contact with the central fixed contact 112A, while the movable contact member 150-1 provided on the front side (X axis positive side) remains in contact with the peripheral fixed contact 114A at the base portion 152, the peripheral fixed contact 114A and the central fixed contact 112A are electrically connected. Therefore, the first system switch SW1 that includes the movable contact member 150-1, is turned on.

Furthermore, as a result, when the elastic arm 151 comes into contact with the central fixed contact 113A, while the movable contact member 150-2 provided on the rear side (X axis negative side) remains in contact with the peripheral fixed contact 115A at the base portion 152, the peripheral fixed contact 115A and the central fixed contact 113A are electrically connected. Therefore, the second system switch SW2 that includes the movable contact member 150-2, is turned on.

In this way, when only one elastic arm 151 is pressed by the drive body 160 for one movable contact member 150 that constitutes one switch in the switch circuit, the switch device 100 according to an embodiment can turn on the one switch in the switch circuit. Therefore, according to the switch device 100 of an embodiment, it is possible to turn on one switch in the switch circuit more reliably with a relatively simple configuration.

Furthermore, the switch device 100 according to an embodiment includes two sets of switches SW1 and SW2 having the same configuration (a configuration including the peripheral fixed contact, the central fixed contact, and the movable contact member) and disposed facing each other in the housing 110.

Furthermore, the switch device 100 according to an embodiment includes one of the movable contact member 150-1 of one switch SW1, and the other elastic arm 151 of the movable contact member 150-2 of the other switch SW2 with the two elastic arms 151 facing each other, and the drive body 160 is pressed by the inversion dome member 130 to move downward, thereby simultaneously pressing down the one elastic arm 151 and the other elastic arm 151.

As a result, when the operator performs the push-down operation on the operation unit 141 of the stem 140, the switch device 100 according to an embodiment can simultaneously turning on the first switch SW1 of the first system and the second switch SW1 of the second system by the drive body 160.

In other words, when only one elastic arm 151 is pressed for the two movable contact members 150-1 and 150-2 that constitute the two switches SW1 and SW2, the switch device 100 according to an embodiment can turn on the two switches SW1 and SW2 in the switch circuit on. Therefore, according to the switch device 100 of an embodiment, it is possible to turn on the two switches SW1 and SW2 in the switch circuit more reliably at the same time with a relatively simple configuration.

Furthermore, when the first switch SW1 of the first system and the second switch SW1 of the second system are simultaneously turned on, the switch device 100 according to an embodiment can present a click sensation to the operator by the inversion dome member 130 performing an inversion motion. Therefore, the switch device 100 according to an embodiment allows the operator to easily perceive by touch that the first switch SW1 of the first system and the second switch SW1 of the second system have been turned on simultaneously.

Specifically, the switch device 100 according to an embodiment presses the pair of elastic arms 151 via the drive body 160 provided movably in the vertical direction (Z axis direction), so that even when the operator performs the push-down operation on the operation unit 141 of the stem 140 in a diagonal direction, the drive body 160 moves more reliably downward (Z axis direction) in the vertical direction, so that the drive body 160 can more reliably press down the pair of elastic arms 151 simultaneously.

Furthermore, the switch device 100 according to an embodiment includes the pair of elastic arms 151 interposed between the inversion dome member 130 and the central fixed contacts 112A and 113A, thereby suppressing the contact noise with the central fixed contacts 112A and 113A caused by the inversion motion of the inversion dome member 130.

Furthermore, since the switch device 100 according to an embodiment is configured such that the inversion dome member 130 does not come into contact with the peripheral fixed contacts 114A and 115A, the peripheral fixed contacts 114A and 115A are not subject to wear due to the inversion motion of the inversion dome member 130, thereby achieving a long service life of the peripheral fixed contacts 114A and 115A.

### First Modification

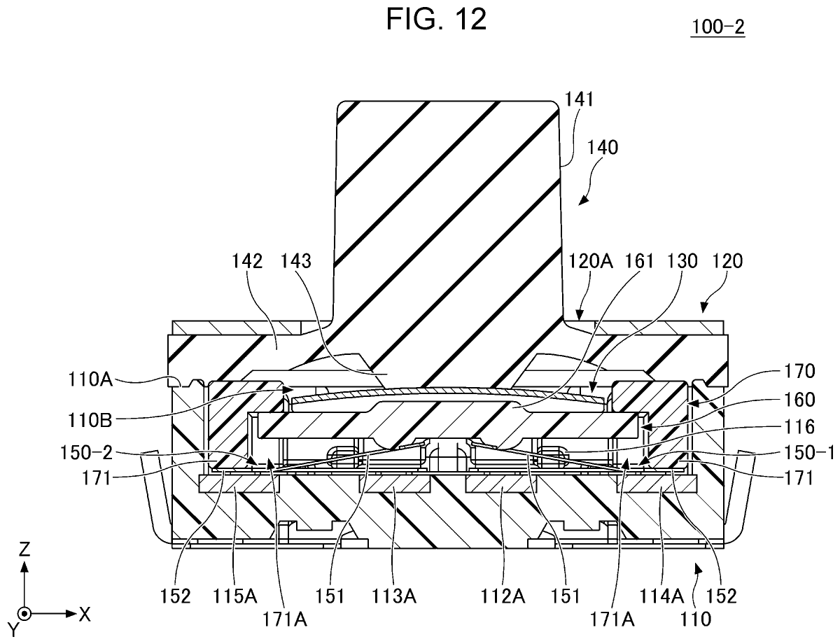

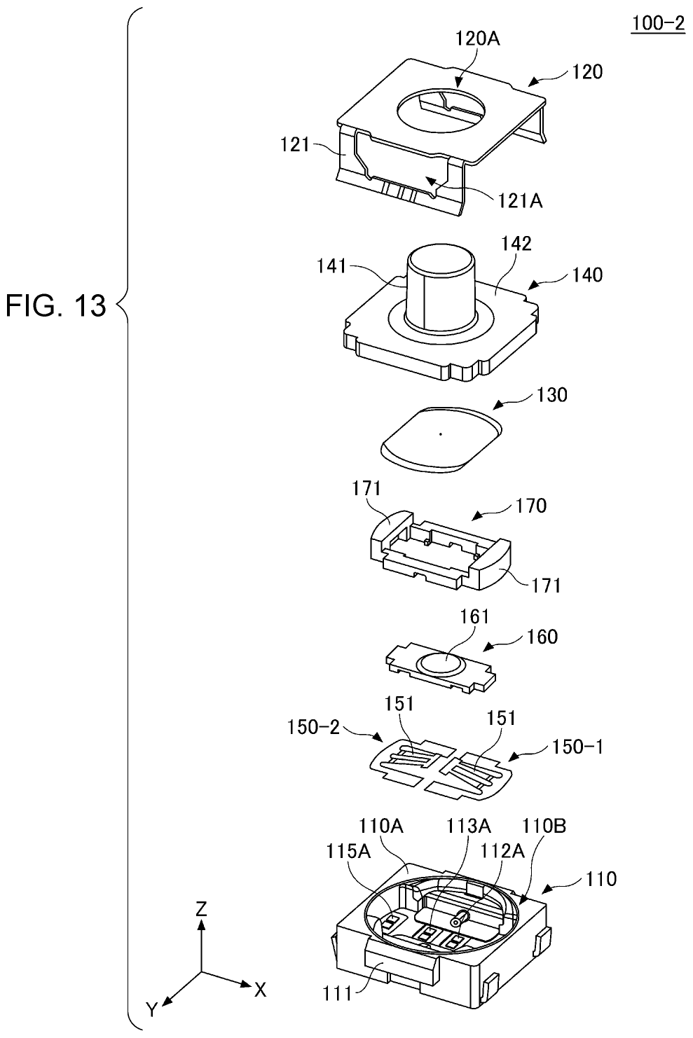

FIG. 12 is a cross-sectional view of a switch device 100-2 according to the first modification of an embodiment. FIG. 13 is an exploded perspective view of the switch device 100-2 according to the first modification of an embodiment. The switch device 100-2 according to the first modification shown in FIGS. 12 and 13 differs from the switch device 100 in that the switch device 100-2 is provided with a pressing member 170 instead of a pressing leg 144 on the stem 140.

The pressing member 170 is a resin member having a substantially rectangular frame shape that is provided between the stem 140 and the movable contact members 150-1 and 150-2 inside the accommodation portion 110B of the housing 110. The pressing member 170 includes a vertical wall-like pressing leg 171 at each of the front end and the rear end.

As shown in FIG. 12, the front side (X axis positive side) pressing leg 171 of the pressing member 170 is pressed from above by the base portion 142 of the stem 140, thereby pressing the base portion 152 of the movable contact member 150-1 from above and pressing the base portion 152 of the movable contact member 150-1 against the peripheral fixed contact 114A.

Furthermore, the rear side (X axis negative side) pressing leg 171 of the pressing member 170 is pressed from above by the base portion 142 of the stem 140, thereby pressing the base portion 152 of the movable contact member 150-2 from above and pressing the base portion 152 of the movable contact member 150-2 against the peripheral fixed contact 115A.

As a result, the switch device 100-2 according to the first modification of an embodiment can stably maintain a state in which the base portion 152 of the movable contact member 150-1 is in contact with the peripheral fixed contact 114A, and a state in which the base portion 152 of the movable contact member 150-2 is in contact with the peripheral fixed contact 115A.

In this way, the pressing leg that presses the base portion 152 of the movable contact members 150-1 and 150-2 may be provided as a separate member from the stem 140.

In the switch device 100-2, the drive body 160 is movable in the vertical direction (Z axis direction) within the frame of pressing member 170. That is, in the switch device 100-2, the drive body 160 is guided in movement in the vertical direction (Z axis direction) by the pressing member 170. Furthermore, in the switch device 100-2, the drive body 160 is positioned at a predetermined height position in its initial state when no pressing operation is being performed on the stem 140, by having the front end and rear end each contact the ceiling face of a groove 171A formed in the pressing leg 171.

In addition, in the switch device 100-2, the drive body 160 has a pair of front-rear second protrusions 164 at the central portion of its lower face, and the pair of front-rear second protrusions 164 pushes down the distal ends of the respective elastic arms 151 of the movable contact members 150-1 and 150-2.

### Second Modification

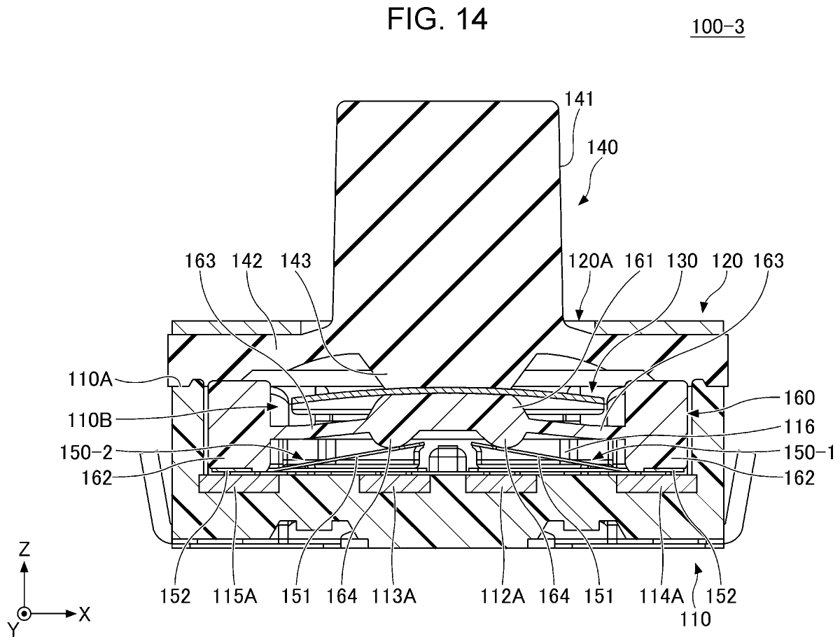

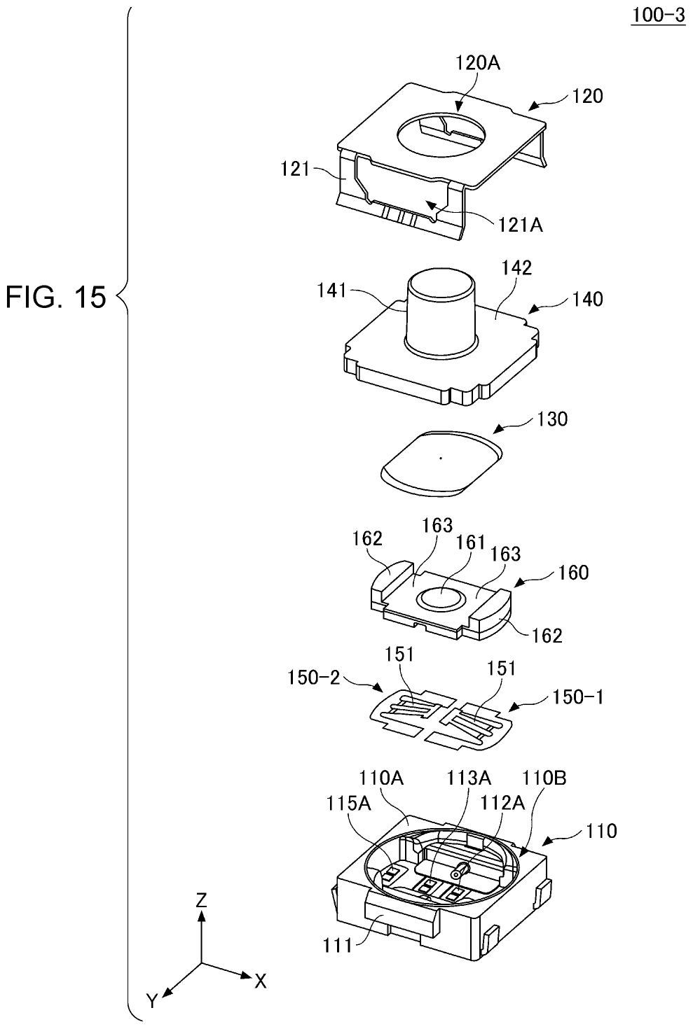

FIG. 14 is a cross-sectional view of a switch device 100-3 according to the second modification of an embodiment. FIG. 15 is an exploded perspective view of the switch device 100-3 according to the second modification of an embodiment. The switch device 100-3 according to the second modification shown in FIGS. 14 and 15 differs from the switch device 100 in that, instead of providing the pressing leg 144 on the stem 140, a pressing leg 162 is integral with the drive body 160. Specifically, in the switch device 100-3, the drive body 160 includes the vertical wall-like pressing leg 162 at each of the front end and the rear end.

As shown in FIG. 14, the front side (X axis positive side) pressing leg 162 of the drive body 160 is pressed from above by the base portion 142 of the stem 140, thereby pressing the base portion 152 of the movable contact member 150-1 from above and pressing the base portion 152 of the movable contact member 150-1 against the peripheral fixed contact 114A.

Furthermore, the rear side (X axis negative side) pressing leg 162 of the drive body 160 is pressed from above by the base portion 142 of the stem 140, thereby pressing the base portion 152 of the movable contact member 150-2 from above and pressing the base portion 152 of the movable contact member 150-2 against the peripheral fixed contact 115A.

As a result, the switch device 100-3 according to the second modification of an embodiment can stably maintain a state in which the base portion 152 of the movable contact member 150-1 is in contact with the peripheral fixed contact 114A, and a state in which the base portion 152 of the movable contact member 150-2 is in contact with the peripheral fixed contact 115A.

In this way, the pressing leg that presses the base portion 152 of each of the movable contact members 150-1 and 150-2 may be integral with the drive body 160.

In the switch device 100-3, the drive body 160 is supported by the pair of front-rear pressing legs 162 so that the central portion that has the protrusion 161 is movable in the vertical direction (Z axis direction). In other words, in the switch device 100-3, the drive body 160 is configured such that a pair of front-rear beams 163 provided between the central portion having the protrusion 161 and the pair of front-rear pressing legs 162 elastically deform, so that the central portion having the protrusion 161 can move in the vertical direction (Z axis direction).

In addition, in the switch device 100-3, the drive body 160 has a pair of front-rear second protrusions 164 at the central portion of its lower face, and the pair of front-rear second protrusions 164 pushes down the distal ends of the elastic arms 151 of the movable contact members 150-1 and 150-2.

Although an embodiment of the present invention is described in detail above, the present invention is not limited to the embodiment, and various modifications or changes are possible within the scope of the gist of the present invention as described in the claims.

What is claimed is:

1. A switch device comprising: a housing having an accommodation portion;
a peripheral fixed contact and a central fixed contact provided at a bottom of the accommodation portion;
a movable contact member including a base portion placed on the bottom of the accommodation portion and in contact with the peripheral fixed contact, an elastic arm extending from a central portion of the base portion and capable of releasably connecting the central fixed contact, and a pair of support legs extending from both ends of the base portion;
an operation member on which an operator performs a push-down operation;
a plate spring provided below the operation member in the accommodation portion and pressed by the operation member; and
a drive body provided above the elastic arm and below the plate spring in the accommodation portion, the drive body causing the elastic arm to contact the central fixed contact by pressed by the plate spring and pushing down the elastic arm.

2. The switch device according to claim 1, wherein
each of the pair of support legs has a shape that is bent along an inner wall of the accommodation portion.

3. The switch device according to claim 1, wherein
the peripheral fixed contact, the central fixed contact, and the movable contact member constitute a switch, and wherein
two sets of the switches having a same configuration are provided facing each other in the housing.

4. The switch device according to claim 3, wherein
one elastic arm included in the movable contact member of one switch of the two sets of switches and the other elastic arm included in the movable contact member of the other switch of the two sets of switches are disposed facing to each other, and wherein
the drive body
simultaneously pushes down the one elastic arm and the other elastic arm.

5. The switch device according to claim 4, wherein
the plate spring presses the drive body by an inversion motion when pressed by the operation member.

6. The switch device according to claim 1, wherein
the plate spring
has a side-cut shape cut by a pair of straight portions parallel to each other with respect to a dome-shaped material having a circular shape in plan view, and
is disposed so that a direction in which the pair of straight portions extends is a direction perpendicular to a direction in which the elastic arm extends.

7. The switch device according to claim 1, wherein
the operation member
includes a pressing leg that is made of an elastic material and presses the base portion of the movable contact member against the peripheral fixed contact.

8. The switch device according to claim 1, further comprising:
a pressing member provided between the operation member and the movable contact member, the pressing member pressing the base portion of the movable contact member against the peripheral fixed contact when pressed by the operation member.

9. The switch device according to claim 1, wherein
the drive body
includes a pressing leg that is made of an elastic material, is disposed between the operation member and the movable contact member, and presses the base portion of the movable contact member against the peripheral fixed contact when pressed by the operation member.
